(19) United States
(12) Patent Application Publication
(10) Pub. No.: US 2026/0166901 A1
(43) Pub. Date: Jun. 18, 2026

(54) FALLING PREVENTION APPARATUS AND IMAGE FORMING APPARATUS

(71) Applicant: Shiro AKAMA, Tokyo (JP)

(72) Inventor: Shiro AKAMA, Tokyo (JP)

(73) Assignee: ETRIA CO., LTD., Yokohama (JP)

(21) Appl. No.: 19/387,026

(22) Filed: Nov. 12, 2025

(30) Foreign Application Priority Data
Dec. 13, 2024 (JP) 2024-218480

(51) Int. Cl. B41J 29/02; B41J 29/06; G03G 21/16

(52) U.S. Cl. CPC B41J 29/02; B41J 29/06; G03G 21/1619; G03G 21/1647

(57) ABSTRACT

A falling prevention apparatus includes: a falling prevention member: attached to a target apparatus; and protruding outward from a side face of the target apparatus with a protrusion amount in a protruding direction; and a protrusion amount changer to change the protrusion amount.

### CROSS-REFERENCE TO RELATED APPLICATIONS

This patent application is based on and claims priority pursuant to 35 U.S.C. § 119(a) to Japanese Patent Application No. 2024-218480, filed on Dec. 13, 2024, in the Japan Patent Office, the entire disclosure of which is hereby incorporated by reference herein.

### BACKGROUND

### Technical Field

The present embodiment relates to a falling prevention apparatus and an image forming apparatus.

### Related Art

The falling prevention apparatus prevents falling of an installation target apparatus installed on an installation surface using a falling prevention member attached to the installation target apparatus.

### SUMMARY

The present disclosure described herein provides a falling prevention apparatus including: a falling prevention member: attached to a target apparatus; and protruding outward from a side face of the target apparatus with a protrusion amount in a protruding direction; and a protrusion amount changer to change the protrusion amount.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a front view illustrating a schematic configuration of an internal structure of an image forming apparatus according to an embodiment;

FIG. 2 is a front view illustrating the image forming apparatus to which a falling prevention apparatus according to the embodiment is attached;

FIG. 3 is a perspective view illustrating a placement table of the falling prevention apparatus;

FIG. 4A is an explanatory view illustrating a state before the image forming apparatus is placed on the placement table;

FIG. 4B is an explanatory view illustrating a state after the image forming apparatus is placed on the placement table;

FIG. 5 is a perspective view illustrating the falling prevention member of the falling prevention apparatus;

FIG. 6A is a perspective view illustrating a protruding member constituting the falling prevention member;

FIG. 6B is an exploded perspective view of the protruding member;

FIG. 7 is a bottom view of the falling prevention member as viewed from below (bottom surface side);

FIG. 8 is a bottom view of the placement table as viewed from below (bottom surface side);

FIG. 9 is an explanatory view of the falling prevention apparatus when a protrusion amount is a minimum amount La;

FIG. 10 is an explanatory view of the falling prevention apparatus when the protrusion amount is an intermediate amount Lb;

FIG. 11 is an explanatory view of the falling prevention apparatus when the protrusion amount is a maximum amount Lc;

FIG. 12 is an explanatory view for explaining a fall angle when the protruding amount of the falling prevention member is the minimum amount La;

FIG. 13 is an explanatory view illustrating an angle θa formed by a straight line Pa and a vertical line P0, the straight line Pa connecting a gravity center position G of the image forming apparatus installed on a horizontal installation surface and an end portion in the protruding direction of the falling prevention member when the protrusion amount of the falling prevention member is the minimum amount La;

FIG. 14 is an explanatory view for explaining the fall angle when the protrusion amount of the falling prevention member is the minimum amount La in the image forming apparatus in which a sheet feeding apparatus is added;

FIG. 15 is an explanatory view for explaining the fall angle when the protrusion amount of the falling prevention member is the maximum amount Lc;

FIG. 16 is a bottom view of a falling prevention member of a falling prevention apparatus according to a modification as viewed from below (bottom surface side);

FIG. 17 is a bottom view of a placement table of the falling prevention apparatus as viewed from below (bottom surface side);

FIG. 18 is an explanatory view of the falling prevention apparatus when the protrusion amount is the minimum amount La;

FIG. 19 is an explanatory view of the falling prevention apparatus when the protrusion amount is the intermediate amount Lb;

FIG. 20 is an explanatory view of the falling prevention apparatus when the protrusion amount is the maximum amount Lc.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, an embodiment in which the falling prevention apparatus is applied to a falling prevention apparatus of an image forming apparatus, which is an installation target apparatus, will be described.

An installation target apparatus to which the falling prevention apparatus according to the present embodiment can be applied is not limited to the image forming apparatus, and the falling prevention apparatus can be widely applied to any apparatuses installed on the installation surface.

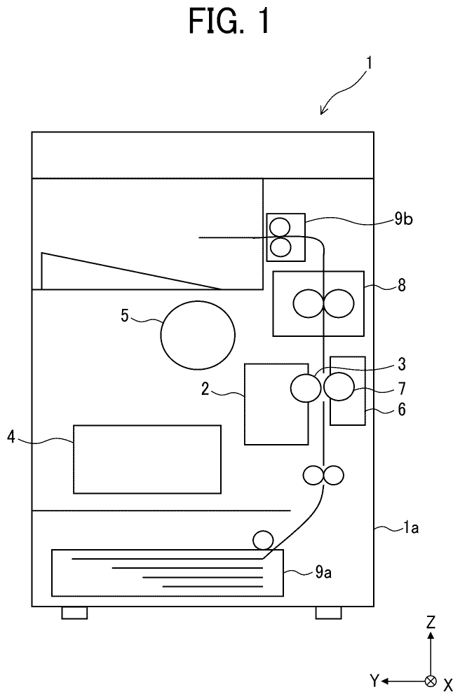

FIG. 1 is a front view illustrating a schematic configuration of an internal structure of an image forming apparatus according to the present embodiment.

Hereinafter, an image forming apparatus 1 will be described as a monochrome machine, but may be a color machine. The image forming apparatus 1 includes a process cartridge 2 for image formation of a toner image of K (black) color in a housing 1a. The process cartridge 2 includes a photoconductor module, a charging module, a developing module, and a cleaning module, and is attachable to and detachable from the main body of the image forming apparatus 1. The process cartridge 2 includes a drum-shaped photoconductor 3.

The image forming apparatus 1 further includes a writing unit 4. The writing unit 4 irradiates the photoconductor 3 charged by the charging module with irradiation light such as laser light to form an electrostatic latent image. The developing module develops the electrostatic latent image with a developing toner. A toner bottle 5 containing the developing toner is provided above the writing unit 4.

A transfer unit 6 includes a transfer roller 7. The transfer roller 7 and the photoconductor 3 abut on each other to form a transfer nip. In the transfer nip, a transfer bias is applied to the transfer roller 7 to form a transfer electric field, and the toner image on the photoconductor 3 is transferred to a recording medium such as a sheet.

The image forming apparatus 1 includes a fixing unit 8 that fixes the toner image transferred onto the recording medium above the transfer unit 6 in the drawing. The fixing unit 8 includes a heating roller including a heat generation element therein. The recording medium after the toner image transfer is conveyed along a conveyance direction of the recording medium toward the fixing unit 8 between the transfer unit 6 and the fixing unit 8.

The image forming apparatus 1 includes a sheet feeding unit 9a that delivers the recording medium to the transfer unit 6 in a lower portion of the housing 1a. The image forming apparatus 1 includes a sheet ejection unit 9b that ejects the recording medium having passed through the fixing unit 8 toward the outside of the apparatus on the left side of the fixing unit 8 in the drawing. Each component provided inside the housing 1a described above, such as the process cartridge 2, constitutes an image forming portion.

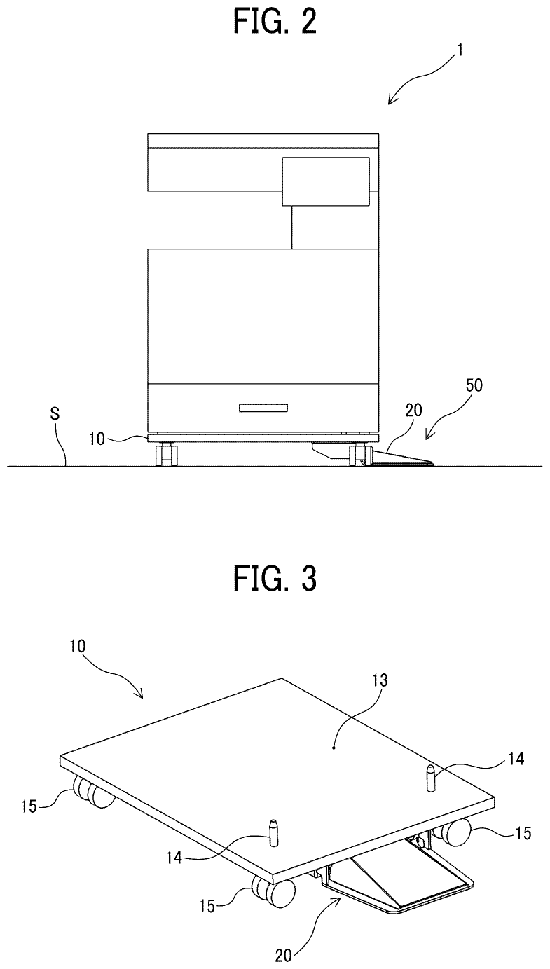

FIG. 2 is a front view illustrating the image forming apparatus to which the falling prevention apparatus according to the present embodiment is attached.

A falling prevention apparatus 50 of the present embodiment is attached to the bottom portion of the image forming apparatus 1 installed on an installation surface S to prevent the image forming apparatus 1 from falling. The falling prevention apparatus 50 mainly includes a placement table 10 as an attachment member to be attached to the bottom portion of the image forming apparatus 1, and a falling prevention member 20 attached to the placement table 10. In the present embodiment, the falling prevention member 20 is provided on the placement table 10, but, the present embodiment is not limited to the configuration in which the falling prevention member 20 is attached to the placement table 10, so that, for example, the falling prevention member 20 may be configured to be attached to the apparatus body of the image forming apparatus 1 or an additional apparatus such as a sheet feeding apparatus or a storage box added to the image forming apparatus 1.

FIG. 3 is a perspective view illustrating the placement table 10 of the falling prevention apparatus 50.

In the present embodiment, the image forming apparatus 1 is placed on the placement table 10 of the falling prevention apparatus 50. The placement table 10 includes an upper surface portion 13 on which the image forming apparatus 1 is placed, positioning pins 14 for positioning the image forming apparatus 1 on the placement table 10, and casters 15 that enable the image forming apparatus 1 to move in a state of being placed on the placement table 10. The falling prevention member 20 protruding in the horizontal direction is attached to the placement table 10 in order to prevent the image forming apparatus 1 from falling.

FIGS. 4A and 4B are explanatory views for explaining an operation of placing the image forming apparatus 1 on the placement table 10.

A bottom portion (bottom surface) of the image forming apparatus 1 is provided with positioning holes into which the positioning pins 14 are fitted at positions facing the positioning pins 14 provided on the placement table 10. When the image forming apparatus 1 is placed on the placement table 10, as illustrated in FIG. 4A, the positioning pins 14 on the placement table 10 are inserted into the positioning holes provided in the bottom portion of the image forming apparatus 1. As a result, as illustrated in FIG. 4B, the image forming apparatus 1 is positioned on the placement table 10, and is placed and attached onto the placement table 10.

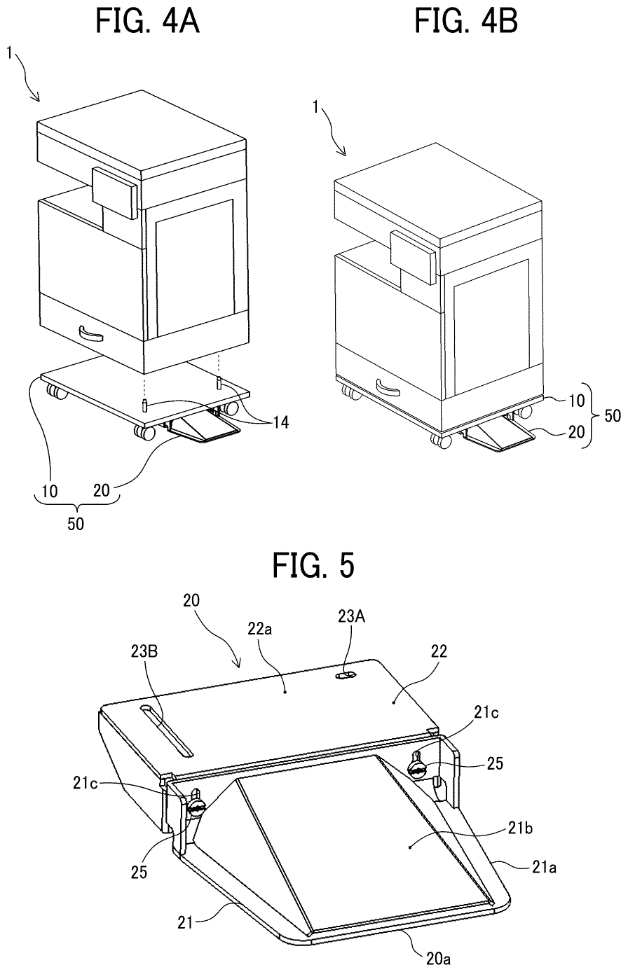

FIG. 5 is a perspective view illustrating the falling prevention member 20 of the falling prevention apparatus 50.

The falling prevention member 20 includes a protruding member 21 and a securing bracket 22, and the protruding member 21 is fastened and secured to the securing bracket 22 by fasteners 25 such as screws. The securing bracket 22 is a portion to be attached and secured to the placement table 10. The protruding member 21 protrudes outward in the horizontal direction with respect to the image forming apparatus, and an end portion of the protruding member 21 in the protruding direction (end portion 20a of the falling prevention member 20) comes into contact with the installation surface S, thereby preventing the image forming apparatus 1 from falling.

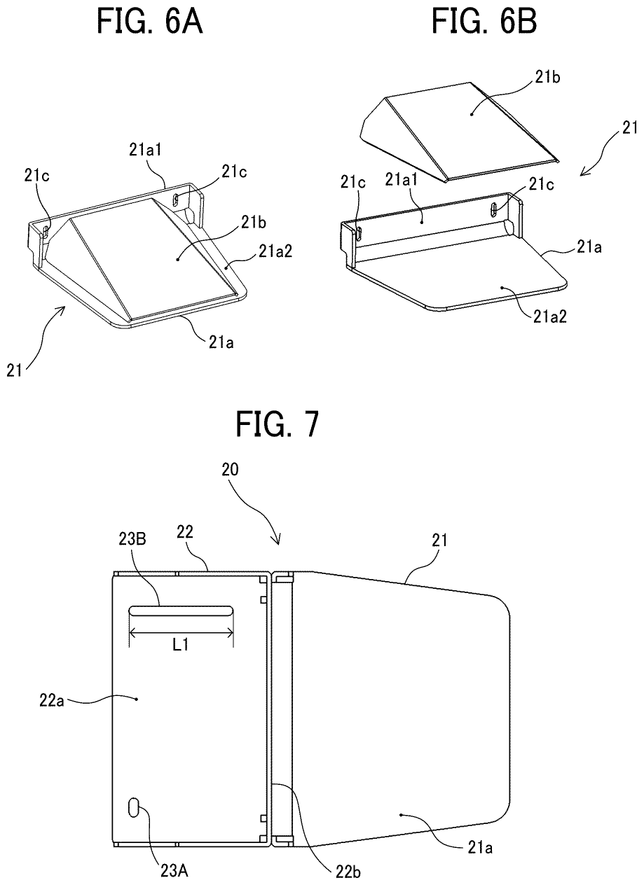

FIG. 6A is a perspective view illustrating the protruding member constituting the falling prevention member 20, and FIG. 6B is an exploded perspective view of the protruding member.

The protruding member 21 includes a bent steel plate portion 21a as a rigid plate member and a reinforcing member 21b as an inclined plate member.

In the bent steel plate portion 21a, one steel plate is bent at 90° to form a vertical surface portion 21a1 and a horizontal surface portion 21a2. Specifically, the bent steel plate portion 21a includes the vertical surface portion 21a1 and the horizontal surface portion 21a2 extending from a lower portion of the vertical surface portion 21a1 in the protruding direction of the protruding member 21. The vertical surface portion 21a1 of the bent steel plate portion 21a is formed with two screw holes 21c into which the fasteners 25 for attaching the protruding member 21 to the securing bracket 22 are inserted. The vertical surface portion 21a1 of the bent steel plate portion 21a is fastened by the fasteners 25 in a state of being in close contact with a vertical surface portion 22b (see FIG. 7) of the securing bracket 22, whereby the protruding member 21 is secured to the securing bracket 22.

The reinforcing member 21b is attached onto the horizontal surface portion 21a2 of the bent steel plate portion 21a. The reinforcing member 21b is formed of a plate-shaped member having an inclined surface inclined downward from the upper portion of the vertical surface portion 21a1 of the bent steel plate portion 21a toward an end side of the horizontal surface portion 21a2 in the extending direction. The reinforcing member 21b is secured to the bent steel plate portion 21a by, for example, welding or a fastener. By providing such a reinforcing member 21b, when the end portion of the protruding member 21 receives an external force from the installation surface S at the time of preventing the image forming apparatus 1 from falling, the reinforcing member 21b can receive a part of the external force in the plate surface direction. As a result, the magnitude of the external force received by the bent portion of the bent steel plate portion 21a (boundary portion between the vertical surface portion 21a1 and the horizontal surface portion 21a2) can be suppressed, and the bent portion of the bent steel plate portion 21a can be suppressed from being deformed. Therefore, the falling prevention member 20 having high rigidity and a sufficient falling prevention function can be obtained.

FIG. 7 is a bottom view of the falling prevention member 20 as viewed from below (bottom surface side).

A horizontal surface portion 22a of the securing bracket 22 is provided with two fastening holes 23A and 23B into which a first fastener 30A and a second fastener 30B such as screws are inserted in order to fasten the securing bracket 22 using the fasteners 30A and 30B on the bottom surface of the placement table 10. Both fastening holes 23A and 23B are constituted by slotted holes set to have substantially the same width as the cross-sectional dimensions of the fasteners 30A and 30B, but are formed such that the longitudinal directions of the slotted holes are orthogonal to each other. As a result, the fasteners 30A and 30B are inserted into and fastened to the two fastening holes 23A and 23B, so that displacement of the securing bracket 22 (falling prevention member 20) in the width direction of each slotted hole is restricted and positioning is performed. Specifically, displacement of the falling prevention member 20 in the protruding direction is restricted by a first fastening hole 23A, which is a slotted hole elongated in a direction orthogonal to the protruding direction, and displacement of the falling prevention member 20 in a direction orthogonal to the protruding direction is restricted by a second fastening hole 23B, which is a slotted hole elongated in the protruding direction.

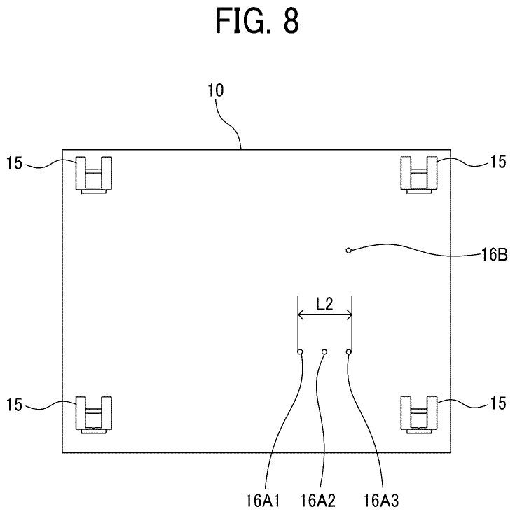

FIG. 8 is a bottom view of the placement table 10 as viewed from below (bottom surface side).

Screw holes 16A1, 16A 2, 16A 3, and 16B as fastening holes for fastening the securing bracket 22 of the falling prevention member 20 with the fasteners 30A and 30B such as screws are provided in the bottom surface of the placement table 10. Specifically, three first screw holes 16A1, 16A 2, and 16A3 corresponding to the first fastening hole 23A of the securing bracket 22 and one second screw hole 16B corresponding to the second fastening hole 23B of the securing bracket 22 are provided. The three first screw holes 16A1, 16A2, and 16A3 are arranged side by side along the protruding direction of the protruding member 21, and the number thereof can be appropriately set from any number of two or more.

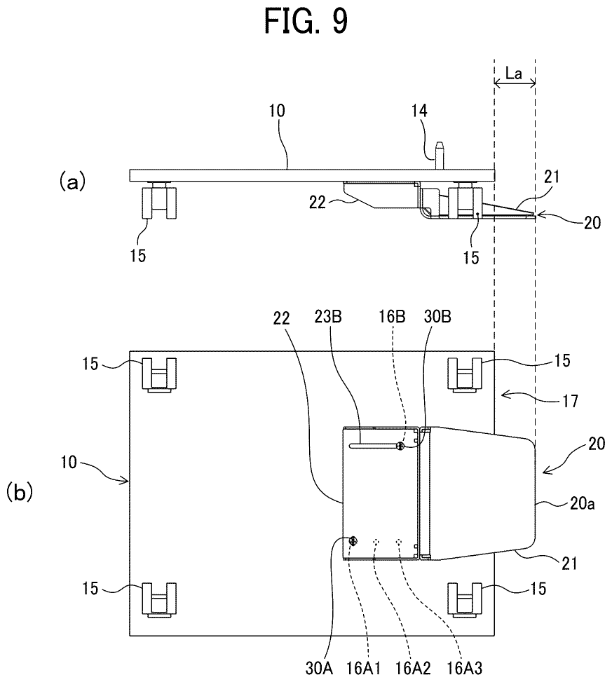

FIG. 9 is an explanatory view illustrating a state where the first fastener 30A is inserted into the first fastening hole 23A of the securing bracket 22 of the falling prevention member 20, and the first fastener 30A is fitted into the first screw hole 16A1 located on the deepest side in the protruding direction among the three first screw holes 16A1 to 16A3 in the bottom surface of the placement table 10. FIG. 9(a) is a front view of the falling prevention apparatus 50 as viewed from the front (front surface) of the apparatus, and FIG. 9(b) is a bottom view of the falling prevention apparatus 50 as viewed from below (bottom surface side).

In the state of FIG. 9, the second fastener 30B is inserted into the second fastening hole 23B (slotted hole elongated in the protruding direction) of the securing bracket 22 of the falling prevention member 20 and fitted into the second screw hole 16B in the bottom surface of the placement table 10. As a result, the vertical surface portion 21a1 of the protruding member 21 and the vertical surface portion 22b of the securing bracket 22 in the falling prevention member 20 are fastened in a state of being approximately parallel to an end surface 17 of an end portion of the placement table 10 in the protruding direction of the falling prevention member 20. As a result, the protruding direction of the falling prevention member 20 becomes a direction approximately perpendicular to the surface of the end portion of the placement table 10, and the falling prevention member 20 is positioned. At this time, the protrusion amount by which the protruding member 21 of the falling prevention member 20 protrudes from the end surface 17 of the placement table 10, that is, the distance from the end surface 17 of the placement table 10 to the end portion of the protruding member 21 in the protruding direction (the end portion 20a of the falling prevention member 20) is La.

Contrary to the present embodiment, the second screw hole 16B in the bottom surface of the placement table 10 may be a through-hole that is a slotted hole elongated in the protruding direction like the second fastening hole 23B of the securing bracket 22 of the falling prevention member 20, and the second fastening hole 23B of the securing bracket 22 of the falling prevention member 20 may be a hole having a diameter substantially equal to the diameter of the fastener instead of the slotted hole. The second fastener 30B may have a configuration of, for example, a bolt and a nut.

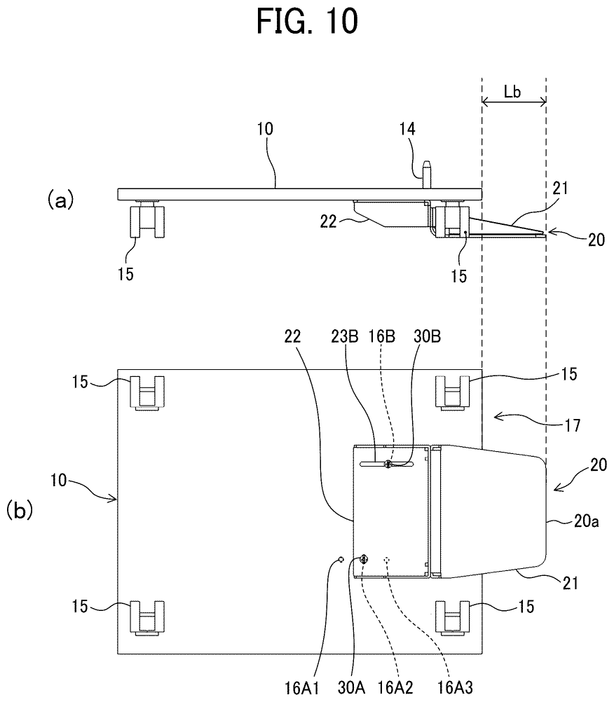

FIG. 10 is an explanatory view illustrating a state where the first fastener 30A is inserted into the first fastening hole 23A of the securing bracket 22 of the falling prevention member 20, and the first fastener 30A is fitted into the first screw hole 16A2 located at the center in the protruding direction among the three first screw holes 16A1 to 16A3 in the bottom surface of the placement table 10. FIG. 10(a) is a front view of the falling prevention apparatus 50 as viewed from the front (front surface) of the apparatus, and FIG. 10(b) is a bottom view of the falling prevention apparatus 50 as viewed from below (bottom surface side).

Also in the state of FIG. 10, the second fastener 30B is inserted into the second fastening hole 23B (slotted hole elongated in the protruding direction) of the securing bracket 22 of the falling prevention member 20 and fitted into the second screw hole 16B in the bottom surface of the placement table 10. As a result, the protruding direction of the falling prevention member 20 becomes a direction approximately perpendicular to the surface of the end portion of the placement table 10, and the falling prevention member 20 is positioned. At this time, the protrusion amount by which the protruding member 21 of the falling prevention member 20 protrudes from the end surface 17 of the placement table 10, that is, the distance from the end surface 17 of the placement table 10 to the end portion of the protruding member 21 in the protruding direction (the end portion 20a of the falling prevention member 20) is Lb larger than La.

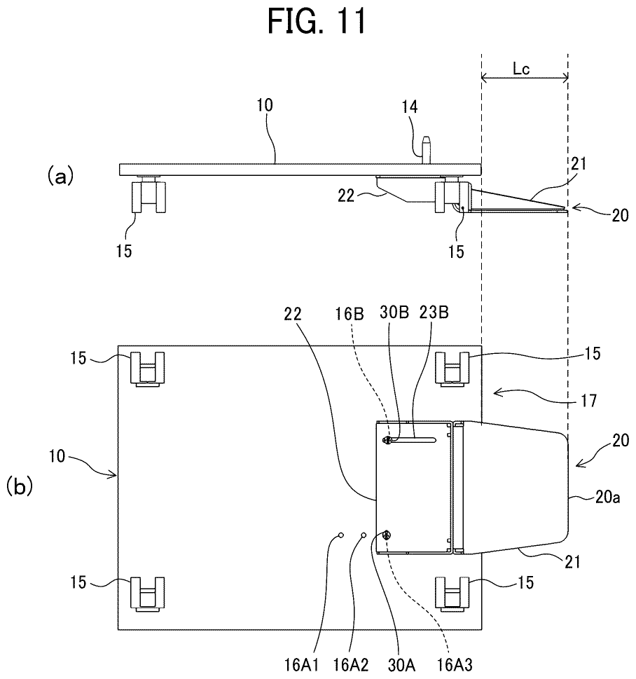

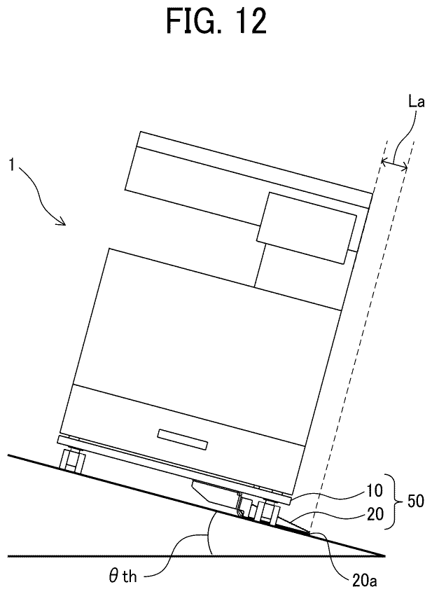

FIG. 11 is an explanatory views illustrating a state where the first fastener 30A is inserted into the first fastening hole 23A of the securing bracket 22 of the falling prevention member 20, and the first fastener 30A is fitted into the first screw hole 16A3 located on the most distal end side in the protruding direction among the three first screw holes 16A1 to 16A3 in the bottom surface of the placement table 10. FIG. 11(a) is a front view of the falling prevention apparatus 50 as viewed from the front (front surface) of the apparatus, and FIG. 11(b) is a bottom view of the falling prevention apparatus 50 as viewed from below (bottom surface side).

Also in the state of FIG. 11, the second fastener 30B is inserted into the second fastening hole 23B (slotted hole elongated in the protruding direction) of the securing bracket 22 of the falling prevention member 20 and fitted into the second screw hole 16B in the bottom surface of the placement table 10. As a result, the protruding direction of the falling prevention member 20 becomes a direction approximately perpendicular to the surface of the end portion of the placement table 10, and the falling prevention member 20 is positioned. At this time, the protrusion amount by which the protruding member 21 of the falling prevention member 20 protrudes from the end surface 17 of the placement table 10, that is, the distance from the end surface 17 of the placement table 10 to the end portion of the protruding member 21 in the protruding direction (the end portion 20a of the falling prevention member 20) is Lc larger than Lb.

As described above, the first fastening hole 23A of the securing bracket 22 of the falling prevention member 20 is fastened by the first fastener 30A using any of the three first screw holes 16A1 to 16A3 in the bottom surface of the placement table 10, so that the protrusion amount of the protruding member 21 of the falling prevention member 20 from the end surface 17 of the placement table 10 can be changed by being selected from La, Lb, and Lc.

In the present embodiment, a longitudinal length L1 (see FIG. 7) of the second fastening hole 23B provided in the securing bracket 22 of the falling prevention member 20 is set equal to or more than a changeable range (adjustable range) of the protrusion amount of the protruding member 21, that is, a distance L2 (see FIG. 8) between the first screw hole 16A1 on the deepest side in the protruding direction and the first screw hole 16A3 on the most distal end side in the protruding direction provided in the bottom surface of the placement table 10. As a result, the second fastening hole 23B alone including one slotted hole can cope with the entire changeable range (adjustable range) of the protrusion amount of the protruding member 21.

In the present embodiment, the falling prevention member 20 having high rigidity is obtained by adopting the protruding member 21 having high rigidity and including the bent steel plate portion 21a and the reinforcing member 21b, so that deformation and breakage at the time of fall prevention can be prevented, and the protrusion amount of the protruding member 21 from the end surface of the placement table 10 can be adjusted. That is, according to the present embodiment, it is possible to provide the falling prevention apparatus 50 that can adjust the protrusion amount of the falling prevention member 20 and having high rigidity.

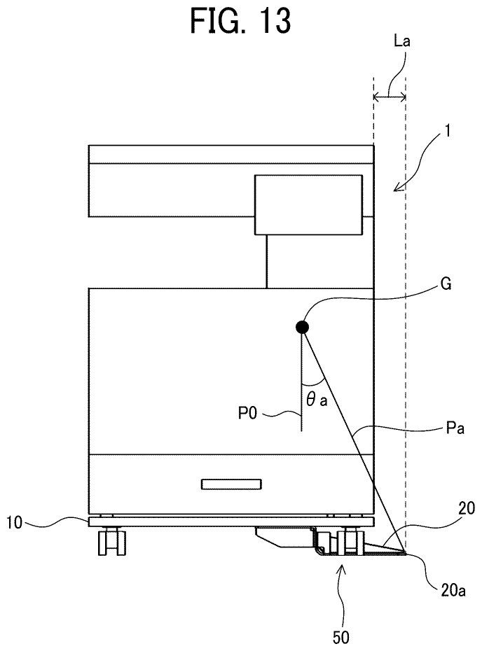

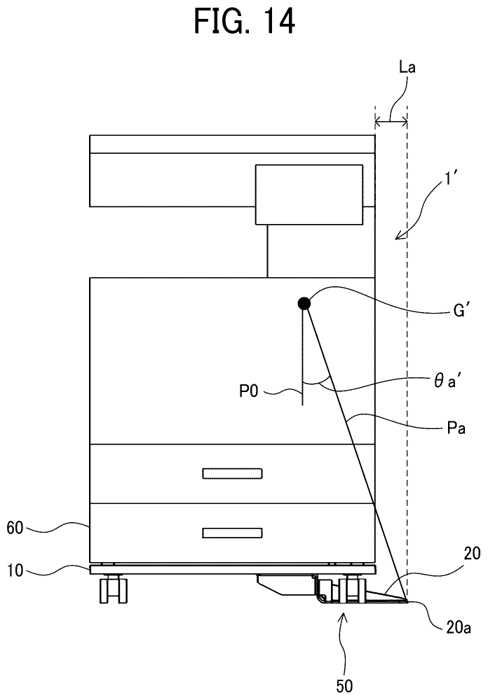

In general, a device such as an image forming apparatus may be demanded to have a fall angle (a maximum angle at which the device does not fall when being tilted) equal to or more than a predetermined angle (for example, 15° or more) according to standards or the like. Therefore, in the present embodiment, as illustrated in FIG. 12, when protrusion amount of the falling prevention member 20 is the minimum amount La, that is, when fastening is performed using the first screw hole 16A1 located on the deepest side in the protruding direction among the three first screw holes 16A1 to 16A3 in the bottom surface of the placement table 10 (state of FIG. 9), the fall angle is configured to be equal to or larger than a predetermined angle θth. As illustrated in FIG. 13, this is achieved by configuring the angle θa, which is formed by the vertical line P0 and the straight line Pa connecting the gravity center position G of the image forming apparatus 1 installed on the horizontal installation surface and the end portion 20a in the protruding direction of the falling prevention member 20 when the protrusion amount of the falling prevention member 20 is the minimum amount La, to be the predetermined angle or more (for example, 15° or more).

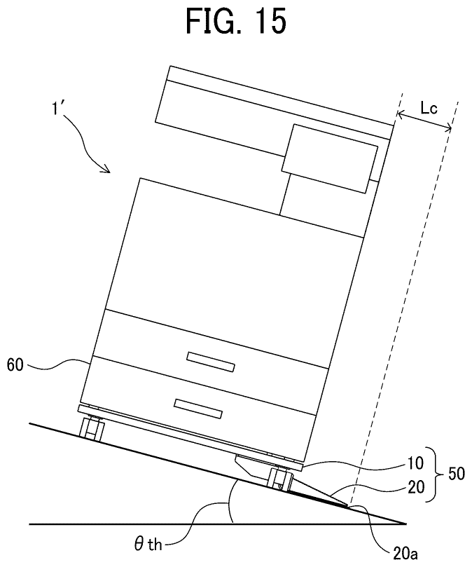

Here, the image forming apparatus 1 may be provided with an optional additional device, and the gravity center position G of the image forming apparatus 1 changes depending on the presence or absence of the additional device, thereby changing the fall angle of the image forming apparatus 1. For example, as illustrated in FIG. 14, in a case where an additional sheet feeding apparatus 60 is installed, a gravity center position G′ of an image forming apparatus 1′including the additional sheet feeding apparatus 60 is higher than the gravity center position G (see FIG. 13) of the image forming apparatus 1 not including the additional sheet feeding apparatus 60, and the fall angle is smaller. As a result, there is a possibility that when the protrusion amount of the falling prevention member 20 is the minimum amount La, the fall angle is less than the prescribed angle. That is, there is a possibility that an angle θa′ formed by the vertical line P0 and the straight line Pa connecting the gravity center position G′ of the image forming apparatus 1′ including the additional sheet feeding apparatus 60 installed on the horizontal installation surface and the end portion 20a in the protruding direction of the falling prevention member 20 when the protrusion amount of the falling prevention member 20 is the minimum amount La is less than the predetermined angle (for example, less than 15°).

In such a case, in the present embodiment, out of the three first screw holes 16A1 to 16A3 provided in the bottom surface of the placement table 10 of the falling prevention apparatus 50, for example, the first screw hole 16A3 located on the most distal end side in the protruding direction is used for fastening by the first fastener 30A. As a result, as illustrated in FIG. 15, the protrusion amount of the protruding member 21 of the falling prevention member 20 protruding from the end surface 17 of the placement table 10 can be set to Lc larger than the minimum amount La. As a result, the fall angle of the image forming apparatus 1 increases, and the fall angle of the image forming apparatus 1 can be made equal to or larger than the prescribed angle.

As described above, in the present embodiment, the protrusion amount of the falling prevention member 20 can be adjusted to cope with a change in the fall angle due to the presence or absence of an additional device such as the additional sheet feeding apparatus 60, so that the falling of the image forming apparatus 1 can be appropriately prevented.

In the conventional configuration that does not have such a function of adjusting the protrusion amount of the falling prevention member 20, it is demanded to assume an apparatus configuration (configuration including an additional device) that is most disadvantageous for the falling and to set the protrusion amount of the falling prevention member to the maximum amount so that the fall angle can be set to the prescribed angle or more even with such a disadvantageous apparatus configuration. In this case, in a configuration having a low falling risk (a configuration having a small fall angle) such as a configuration not including an additional device, the falling prevention member protrudes more than necessary, and the installation area (occupied area) of the image forming apparatus 1 becomes larger than necessary. In the conventional configuration, since the protrusion amount of the falling prevention member is set to the maximum amount, the packaging size of the falling prevention apparatus also increases.

In the present embodiment, in the case of the configuration in which the fall angle is small such as a state where the image forming apparatus 1 does not include an additional device such as the additional sheet feeding apparatus 60, the protrusion amount of the falling prevention member 20 can be adjusted to the minimum amount La and the installation area of the image forming apparatus 1 can be reduced. In the case of the configuration in which the fall angle is large such as a state where the image forming apparatus 1 includes an additional device such as the additional sheet feeding apparatus 60, the protrusion amount of the falling prevention member 20 can be adjusted to Lb or Lc larger than the minimum amount La and the fall angle can be increased. Therefore, according to the present embodiment, by adjusting the protrusion amount of the falling prevention member 20 to a necessary and sufficient protrusion amount with respect to the fall angle that changes according to the presence or absence of an additional device of the image forming apparatus 1, it is possible to suppress the installation area of the image forming apparatus 1 from becoming larger than necessary while securing an appropriate fall angle at which the falling of the image forming apparatus 1 can be prevented. By performing packaging in a state where the protrusion amount of the falling prevention member 20 is adjusted to the minimum amount La, the packaging size of the falling prevention apparatus can be reduced.

### Modification

Next, a modification of the falling prevention apparatus 50 of the present embodiment will be described.

In the present modification, description overlapping with the description of the above-described embodiment will be appropriately omitted.

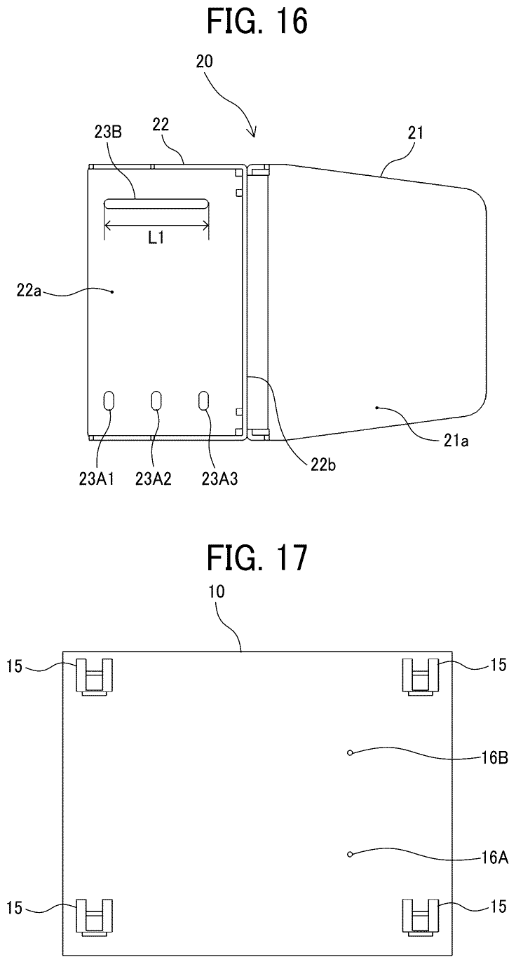

FIG. 16 is a bottom view of the falling prevention member 20 of the falling prevention apparatus 50 according to the present modification as viewed from below (bottom surface side).

FIG. 17 is a bottom view of the placement table 10 of the falling prevention apparatus 50 according to the present modification as viewed from below (bottom surface side).

The above-described embodiment has a configuration in which the protrusion amounts La, Lb, and Lc of the falling prevention member 20 can be selectively changed such that the three first screw holes 16A1, 16A2, and 16A3 are arranged side by side in the protruding direction of the falling prevention member 20 in the bottom surface of the placement table 10 and fastening is performed by the first fastener 30A using any one of the first screw holes. On the other hand, the present modification has a configuration in which the protrusion amount of the falling prevention member 20 can be selectively changed such that, as illustrated in FIG. 16, three first fastening holes 23A1, 23A2, and 23A3 are arranged side by side in the protruding direction of the falling prevention member 20 in the securing bracket 22 of the falling prevention member 20 and fastening is performed by the first fastener 30A using any one of the first fastening holes. The number of the three first fastening holes 23A1, 23A2, and 23A3 can be appropriately set from any number of two or more.

In the present modification, as illustrated in FIG. 17, it is sufficient if the bottom surface of the placement table 10 is provided with one first screw hole 16A corresponding to the three first fastening holes 23A1, 23A2, and 23A3 provided in the securing bracket 22 and one second screw hole 16B corresponding to the second fastening hole 23B formed of one slotted hole provided in the securing bracket 22.

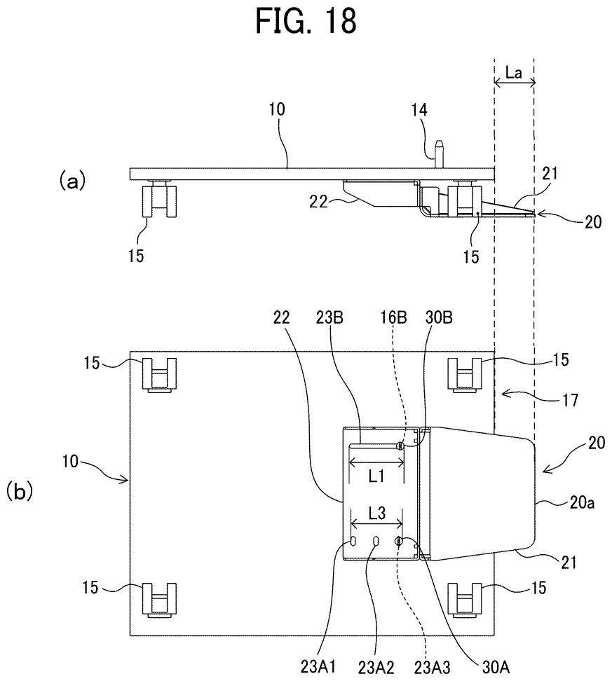

FIG. 18 is an explanatory views illustrating a state in which the first fastener 30A is inserted into the first fastening hole 23A3 located on the most distal end side in the protruding direction among the three first fastening holes 23A1 to 23A3 in the securing bracket 22 of the falling prevention member 20, and the first fastener 30A is fitted into the first screw hole 16A in the bottom surface of the placement table 10. FIG. 18(a) is a front view of the falling prevention apparatus 50 as viewed from the front (front surface) of the apparatus, and FIG. 18(b) is a bottom view of the falling prevention apparatus 50 as viewed from below (bottom surface side).

In the state of FIG. 18, the second fastener 30B is inserted into the second fastening hole 23B (slotted hole elongated in the protruding direction) of the securing bracket 22 of the falling prevention member 20 and fitted into the second screw hole 16B in the bottom surface of the placement table 10. As a result, the protruding direction of the falling prevention member 20 becomes a direction approximately perpendicular to the surface of the end portion of the placement table 10, and the falling prevention member 20 is positioned. At this time, the protrusion amount by which the protruding member 21 of the falling prevention member 20 protrudes from the end surface 17 of the placement table 10, that is, the distance from the end surface 17 of the placement table 10 to the end portion of the protruding member 21 in the protruding direction is La.

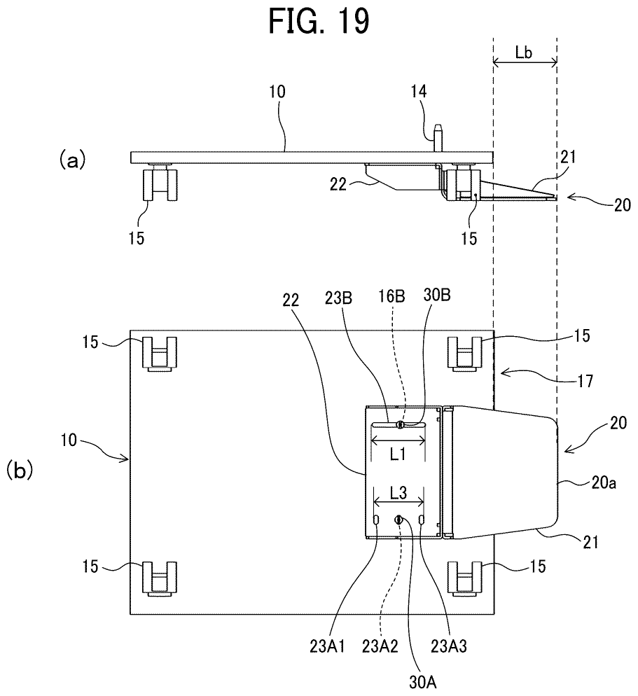

FIG. 19 is an explanatory view illustrating a state in which the first fastener 30A is inserted into the first fastening hole 23A2 located at the center in the protruding direction among the three first fastening holes 23A1 to 23A3 in the securing bracket 22 of the falling prevention member 20, and the first fastener 30A is fitted into the first screw hole 16A in the bottom surface of the placement table 10. FIG. 19(a) is a front view of the falling prevention apparatus 50 as viewed from the front (front surface) of the apparatus, and FIG. 19(b) is a bottom view of the falling prevention apparatus 50 as viewed from below (bottom surface side).

Also in the state of FIG. 19, the second fastener 30B is inserted into the second fastening hole 23B (slotted hole elongated in the protruding direction) of the securing bracket 22 of the falling prevention member 20 and fitted into the second screw hole 16B in the bottom surface of the placement table 10. As a result, the protruding direction of the falling prevention member 20 becomes a direction approximately perpendicular to the surface of the end portion of the placement table 10, and the falling prevention member 20 is positioned. At this time, the protrusion amount by which the protruding member 21 of the falling prevention member 20 protrudes from the end surface 17 of the placement table 10, that is, the distance from the end surface 17 of the placement table 10 to the end portion of the protruding member 21 in the protruding direction is Lb larger than La.

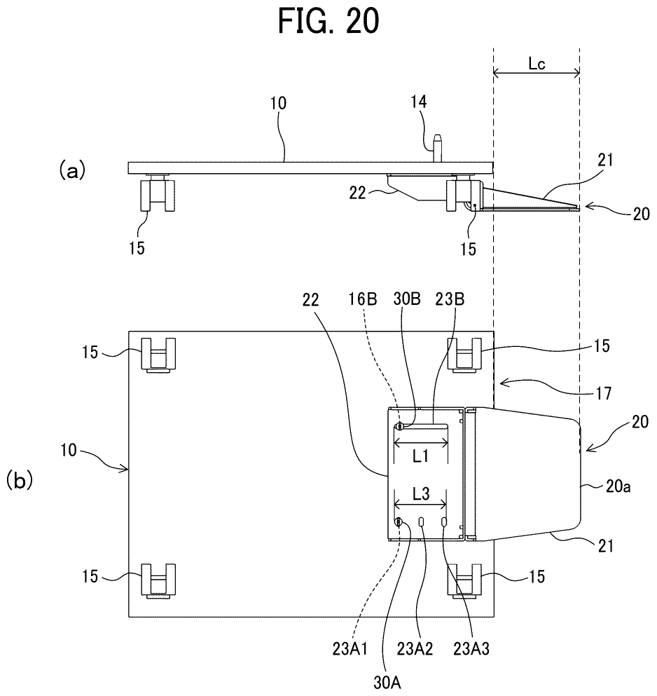

FIG. 20 is an explanatory view illustrating a state in which the first fastener 30A is inserted into the first fastening hole 23A1 located on the deepest side in the protruding direction among the three first fastening holes 23A1 to 23A3 in the securing bracket 22 of the falling prevention member 20, and the first fastener 30A is fitted into the first screw hole 16A in the bottom surface of the placement table 10. FIG. 20(a) is a front view of the falling prevention apparatus 50 as viewed from the front (front surface) of the apparatus, and FIG. 20(b) is a bottom view of the falling prevention apparatus 50 as viewed from below (bottom surface side).

Also in the state of FIG. 20, the second fastener 30B is inserted into the second fastening hole 23B (slotted hole elongated in the protruding direction) of the securing bracket 22 of the falling prevention member 20 and fitted into the second screw hole 16B in the bottom surface of the placement table 10. As a result, the protruding direction of the falling prevention member 20 becomes a direction approximately perpendicular to the surface of the end portion of the placement table 10, and the falling prevention member 20 is positioned. At this time, the protrusion amount by which the protruding member 21 of the falling prevention member 20 protrudes from the end surface 17 of the placement table 10, that is, the distance from the end surface 17 of the placement table 10 to the end portion of the protruding member 21 in the protruding direction is Lc larger than Lb.

In the present modification, by fastening the first fastener 30A to the first screw hole 16A in the bottom surface of the placement table 10 using any one of the three first fastening holes 23A1 to 23A3 in the securing bracket 22 of the falling prevention member 20, the protrusion amount of the protruding member 21 of the falling prevention member 20 from the end surface 17 of the placement table 10 can be changed by being selected from La, Lb, and Lc.

In the present modification, the longitudinal length L1 (see FIG. 7) of the second fastening hole 23B provided in the securing bracket 22 of the falling prevention member 20 is set equal to or more than a changeable range (adjustable range) of the protrusion amount of the protruding member 21, that is, a distance L3 between the first fastening hole 23A1 on the deepest side in the protruding direction and the first fastening hole 23A3 on the most distal end side in the protruding direction provided in the securing bracket 22 of the falling prevention member 20. As a result, the second fastening hole 23B alone including one slotted hole can cope with the entire changeable range (adjustable range) of the protrusion amount of the protruding member 21.

Although a preferred embodiment of the present embodiment has been described above, the present embodiment is not limited to such a specific embodiment. Unless particularly limited in the above description, various modifications and changes can be made without departing from the scope of the gist of the present embodiment recited in the claims.

For example, the image forming apparatus of the present embodiment includes an electrophotographic image forming portion, but can also be applied to those including an image forming portion of another image forming method such as an inkjet method. The effects described in the embodiment of the present embodiment are merely a list of the most preferable effects generated from the present embodiment. Thus, the effects of the present embodiment are not limited to the effects described in the embodiment of the present embodiment.

According to the present embodiment, even when there is a change in the gravity center position of an installation target apparatus, it is possible to suppress an increase in the installation area of the installation target apparatus more than necessary while obtaining an appropriate fall angle at which the falling of the installation target apparatus can be prevented.

A falling prevention apparatus includes: a falling prevention member: attached to a target apparatus; and protruding outward from a side face of the target apparatus with a protrusion amount in a protruding direction; and a protrusion amount changer to change the protrusion amount.

The falling prevention apparatus according includes: an attachment mounted on a bottom face of the target apparatus. The falling prevention member is attached to the attachment, the protrusion amount changer includes an attachment position changer on the attachment, and the protrusion amount changer to change an attachment position of the falling prevention member to the attachment.

The falling prevention apparatus further includes a fastener to fasten the falling prevention member to the attachment. The falling prevention member has a fastening hole having a slotted hole on the falling prevention member, the slotted hole elongated in a transverse direction orthogonal to the protruding direction, the fastener is insertable into the fastening hole in an insertion direction, and the fastener is: allowed to displace along the fastening hole in the transverse direction; and restricted to displace in the protruding direction.

The falling prevention apparatus further includes a fastener to fasten the falling prevention member to the attachment. The falling prevention member has a fastening hole having a slotted hole on the attachment, the slotted hole elongated in a transverse direction orthogonal to the protruding direction, the fastener is insertable into the fastening hole in an insertion direction, and the fastener is: allowed to displace along the fastening hole in the transverse direction; and restricted to displace in the protruding direction.

The falling prevention apparatus further includes a fastener to fasten the falling prevention member to the attachment. The attachment position changer includes multiple fastening holes arrayed in the protruding direction on the falling prevention member, and the multiple fastening holes restricts displacement of the fastener in both of: the protruding direction; and a transverse direction orthogonal to the protruding direction.

The falling prevention apparatus further includes a fastener to fasten the falling prevention member to the attachment. The attachment position changer includes multiple fastening holes arrayed in the protruding direction on the attachment, and the multiple fastening holes restrict displacement of the fastener in both of: the protruding direction; and a transverse direction orthogonal to the protruding direction.

The falling prevention member further has another fastening hole having a slotted hole on the falling prevention member, the slotted hole elongated in the protrusion direction, the fastener is insertable into said another fastening hole in the insertion direction, and the fastener is: allowed to displace along said another fastening hole in the protrusion direction; and restricted to displace in the transverse direction.

The falling prevention member further has another fastening hole having a slotted hole on the attachment, the slotted hole elongated in the protruding direction, the fastener is insertable into said another fastening hole in the insertion direction, and the fastener is: allowed to displace along said another fastening hole in the protruding direction; and restricted to displace in the transverse direction.

The attachment position changer has multiple fastening holes arrayed in the protruding direction on the falling prevention member, said another fastening hole has a longitudinal length equal to or longer than the protrusion amount of the falling prevention member from the side face of the target apparatus in the protruding direction, and the protrusion amount is according to a distance between each end of the multiple fastening holes in the protrusion direction.

The falling prevention member includes: a rigid plate including: a vertical surface portion; and a horizontal surface portion having one end attached to a lower portion of the vertical surface portion and extending in the protruding direction, and an inclined plate inclined downward from an upper portion of the vertical surface portion toward another end of the horizontal surface portion in the protruding direction.

An image forming apparatus includes the falling prevention apparatus, and the image forming apparatus is installed on an installation surface. The protrusion amount changer decreases the protrusion amount to the minimum amount to reduce an angle equal to or larger than a predetermined angle, the angle is formed by: a straight line connecting a gravity center of the target apparatus on a horizontal surface and an end portion of the falling prevention member in the protruding direction; and a vertical line.

An image forming apparatus includes the falling prevention apparatus, and the image forming apparatus is installed on an installation surface. The protrusion amount changer increases the protrusion amount to a maximum amount to increase an angle equal to or larger than a predetermined angle, the angle is formed by: a straight line connecting a gravity center of the target apparatus on a horizontal surface and an end portion of the falling prevention member in the protruding direction; and a vertical line.

An image forming apparatus includes the falling prevention apparatus according to claim 1, the image forming apparatus installed on an installation surface.

The above description is an example, and specific effects are obtained for each of the following aspects.

### Aspect 1

According to Aspect 1, the falling prevention apparatus 50 that prevents falling of an installation target apparatus (for example, the image forming apparatus 1) installed on the installation surface S using the falling prevention member 20 attached to the installation target apparatus, includes: a protrusion amount change portion (for example, the first screw holes 16A1 to 16A3 and the second fastening hole 23B) that changes a protrusion amount of the falling prevention member protruding outward in a horizontal direction from the installation target apparatus.

The installation target apparatus to which the falling prevention apparatus is attached may be retrofitted with another apparatus (such as an optional apparatus), or a user may place or attach some other member on the installation target apparatus. In such a case, since the gravity center position of the installation target apparatus changes, the fall angle of the installation target apparatus changes. In the conventional falling prevention apparatus, it is demanded that the fall angle of the installation target apparatus be sufficiently larger than the prescribed angle in advance so that the installation target apparatus can be prevented from falling even when such a change in the gravity center position occurs. However, in order to increase the fall angle of the installation target apparatus, it is necessary to increase the protrusion amount of the falling prevention member from the installation target apparatus, so that the installation area of the installation target apparatus is increased by the protrusion amount. Therefore, for an installation target apparatus to which another apparatus (an optional apparatus or the like) or another member is not retrofitted, an installation target apparatus from which another apparatus or another member originally attached is removed, or the like, the fall angle of the installation target apparatus is larger than necessary, and the installation area of the installation target apparatus is larger than necessary.

In the present aspect, by changing the protrusion amount of the falling prevention member protruding outward in the horizontal direction from the installation target apparatus by the protrusion amount change portion, the fall angle of the installation target apparatus can be changed. Therefore, the protrusion amount of the falling prevention member can be changed so as to obtain an appropriate fall angle in response to a change in the gravity center position of the installation target apparatus due to the presence or absence of retrofitting of another apparatus (an optional apparatus or the like) or another member, the presence or absence of removal of another apparatus or another member from the installation target apparatus, and the like. As a result, even when there is a change in the gravity center position of the installation target apparatus, it is possible to suppress an increase in the installation area of the installation target apparatus more than necessary while obtaining an appropriate fall angle at which the falling of the installation target apparatus can be prevented.

### Aspect 2

According to Aspect 2, the falling prevention apparatus of Aspect 1 includes an attachment member (for example, the placement table 10) for attaching the falling prevention member to the installation target apparatus, wherein the protrusion amount change portion includes an attachment position change portion (for example, the first screw holes 16A1 to 16A3 and the second fastening hole 23B) that is provided on the attachment member and changes an attachment position of the falling prevention member with respect to the installation target apparatus.

According to this, the protrusion amount of the falling prevention member can be changed merely by changing the attachment position of the falling prevention member with respect to the installation target apparatus.

### Aspect 3

According to Aspect 3, in the falling prevention apparatus of Aspect 2, the attachment member includes an attaching member (for example, the placement table 10) to be attached to the installation target apparatus and the fasteners 30A and 30B that fasten the falling prevention member to the attaching member, and the attachment position change portion includes a fastening hole (for example, the second fastening hole 23B) that is a slotted hole being a hole on the falling prevention member into which the fastener is inserted, the fastening hole restricting displacement of the fastener in a direction orthogonal to a protruding direction of the falling prevention member and enabling displacement of the fastener in the protruding direction.

According to this, the protrusion amount of the falling prevention member can be changed by changing the fastening position of the fastener along the slotted hole shape of the fastening hole on the falling prevention member.

### Aspect 4

According to Aspect 4, in the falling prevention apparatus of Aspect 2, the attachment member includes an attaching member (for example, the placement table 10) to be attached to the installation target apparatus and the fasteners 30A and 30B that fasten the falling prevention member to the attaching member, and the attachment position change portion includes a fastening hole that is a slotted hole being a hole on the attaching member into which the fastener is inserted, the fastening hole restricting displacement of the inserted fastener in a direction orthogonal to a protruding direction of the falling prevention member and enabling displacement of the fastener in the protruding direction.

According to this, similarly to Aspect 3, the protrusion amount of the falling prevention member can be changed by changing the fastening position of the fastener along the slotted hole shape of the fastening hole on the attaching member.

### Aspect 5

According to Aspect 5, in the falling prevention apparatus of Aspect 2, the attachment member includes an attaching member (for example, the placement table 10) to be attached to the installation target apparatus and the fasteners 30A and 30B that fasten the falling prevention member to the attaching member, and the attachment position change portion includes multiple fastening holes (for example, the first fastening holes 23A1 to 23A3) that restricts displacement of the fastener to be inserted in both directions: a protruding direction of the falling prevention member and a direction orthogonal to the protruding direction and is arranged side by side in the protruding direction on the falling prevention member.

According to this, the protrusion amount of the falling prevention member can be changed by selecting the fastening hole used for fastening of the fastener from the multiple fastening holes arranged on the falling prevention member.

### Aspect 6

According to Aspect 6, in the falling prevention apparatus of Aspect 2, the attachment member includes an attaching member (for example, the placement table 10) to be attached to the installation target apparatus and the fasteners 30A and 30B that fasten the falling prevention member to the attaching member, and the attachment position change portion includes multiple fastening holes (for example, the first screw holes 16A1 to 16A3) that restricts displacement of the fastener to be inserted in both directions: a protruding direction of the falling prevention member and a direction orthogonal to the protruding direction and is arranged side by side in the protruding direction on the attaching member.

According to this, the protrusion amount of the falling prevention member can be changed by selecting the fastening hole used for fastening of the fastener from the multiple fastening holes arranged in the attaching member.

### Aspect 7

According to Aspect 7, in the falling prevention apparatus of Aspect 5 or 6, the attachment position change portion includes a second fastening hole (for example, the second fastening hole 23B) that is a slotted hole being a hole on the falling prevention member into which the fastener is inserted, the second fastening hole restricting displacement of the fastener in a direction orthogonal to a protruding direction of the falling prevention member and enabling displacement of the fastener in the protruding direction.

According to this, it is possible to perform fastening at, at least two locations of the multiple fastening holes on the falling prevention member or the attaching member and the second fastening hole on the falling prevention member. According to the present aspect, it is possible to more firmly position and secure the falling prevention member to the attaching member while the protrusion amount of the falling prevention member can be changed.

### Aspect 8

According to Aspect 8, in the falling prevention apparatus of Aspect 5 or 6, the attachment position change portion includes a second fastening hole that is a slotted hole being a hole on the attaching member into which the fastener is inserted, the second fastening hole restricting displacement of the inserted fastener in a direction orthogonal to a protruding direction of the falling prevention member and enabling displacement of the fastener in the protruding direction.

According to this, similarly to Aspect 7, it is possible to perform fastening at, at least two locations of the multiple fastening holes on the falling prevention member or the attaching member and the second fastening hole on the attaching member. According to the present aspect, it is possible to more firmly position and secure the falling prevention member to the attaching member while the protrusion amount of the falling prevention member can be changed.

### Aspect 9

According to Aspect 9, in the falling prevention apparatus of Aspect 7 or 8, a longitudinal length of the second fastening hole is equal to or longer than a changeable range of a protrusion amount of the falling prevention member changeable by the multiple fastening holes.

According to this, it is possible to cope with the entire area of the changeable range of the protrusion amount of the falling prevention member merely by configuring the second fastening hole with one slotted hole.

### Aspect 10

According to Aspect 10, in the falling prevention apparatus of any of Aspects 1 to 9,the falling prevention member includes a rigid plate member (for example, the bent steel plate portion 21a) including the vertical surface portion 21a1 and the horizontal surface portion 21a2 extending from a lower portion of the vertical surface portion in a protruding direction of the falling prevention member, and an inclined plate member (for example, the reinforcing member 21b) inclined downward from an upper portion of the vertical surface portion toward an end side in an extending direction of the horizontal surface portion.

According to this, it is possible to obtain the falling prevention member having high rigidity and a sufficient falling prevention function.

### Aspect 11

According to Aspect 11, in the falling prevention apparatus of any of Aspects 1 to 10,the protrusion amount change portion is configured such that when a protrusion amount of the falling prevention member is a minimum amount La, the angle θa formed by the straight line Pa connecting the gravity center position G of the installation target apparatus installed on a horizontal installation surface and the end portion 20a of the falling prevention member in a protruding direction and the vertical line P0 is a predetermined angle or more (for example, 15° or more).

According to this, for example, even in a case where the installation target apparatus is changed to an apparatus configuration in which the fall angle increases, it is possible to increase the fall angle by increasing the protrusion amount of the falling prevention member 20 by that amount. As a result, even when the installation target apparatus is changed to an apparatus configuration in which the fall angle increases, it is possible to suppress an increase in the installation area of the image forming apparatus 1 more than necessary while securing an appropriate fall angle at which the falling of the image forming apparatus 1 can be prevented.

### Aspect 12

According to Aspect 12, in the falling prevention apparatus of any of Aspects 1 to 10,the protrusion amount change portion is configured such that when a protrusion amount of the falling prevention member is a maximum amount Lc, the angle formed by the straight line connecting the gravity center position of the installation target apparatus installed on a horizontal installation surface and the end portion of the falling prevention member in a protruding direction and the vertical line is a predetermined angle or more.

According to this, for example, even in a case where the installation target apparatus is changed to an apparatus configuration in which the fall angle decreases (for example, in a case where another apparatus or another member originally attached is removed, or the like), it is possible to reduce the protrusion amount of the falling prevention member 20 by that amount and reduce the installation area of the image forming apparatus 1. As a result, even when the installation target apparatus is changed to an apparatus configuration in which the fall angle decreases, it is possible to suppress an increase in the installation area of the image forming apparatus 1 more than necessary while securing an appropriate fall angle at which the falling of the image forming apparatus 1 can be prevented.

### Aspect 13

According to Aspect 13, an image forming apparatus installed on an installation surface, includes the falling prevention apparatus 50 of any of Aspects 1 to 12.

According to this, even when there is a change in the gravity center position of an image forming apparatus, it is possible to suppress an increase in the installation area of the image forming apparatus more than necessary while obtaining an appropriate fall angle at which the falling of the image forming apparatus can be prevented.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A falling prevention apparatus, comprising:
a falling prevention member:
attached to a target apparatus; and
protruding outward from a side face of the target apparatus with a protrusion amount in a protruding direction; and
a protrusion amount changer to change the protrusion amount.

2. The falling prevention apparatus according to claim 1, comprising:
an attachment mounted on a bottom face of the target apparatus,
wherein the falling prevention member is attached to the attachment,
the protrusion amount changer includes an attachment position changer on the attachment, and
the protrusion amount changer to change an attachment position of the falling prevention member to the attachment.

3. The falling prevention apparatus according to claim 2, further comprising a fastener to fasten the falling prevention member to the attachment,
wherein the falling prevention member has a fastening hole having a slotted hole on the falling prevention member, the slotted hole elongated in a transverse direction orthogonal to the protruding direction,
the fastener is insertable into the fastening hole in an insertion direction, and
the fastener is:
allowed to displace along the fastening hole in the transverse direction; and
restricted to displace in the protruding direction.

4. The falling prevention apparatus according to claim 2, further comprising a fastener to fasten the falling prevention member to the attachment,
wherein the falling prevention member has a fastening hole having a slotted hole on the attachment, the slotted hole elongated in a transverse direction orthogonal to the protruding direction,
the fastener is insertable into the fastening hole in an insertion direction, and
the fastener is:
allowed to displace along the fastening hole in the transverse direction; and
restricted to displace in the protruding direction.

5. The falling prevention apparatus according to claim 2, further comprising a fastener to fasten the falling prevention member to the attachment,
wherein the attachment position changer includes multiple fastening holes arrayed in the protruding direction on the falling prevention member, and
the multiple fastening holes restricts displacement of the fastener in both of:
the protruding direction; and
a transverse direction orthogonal to the protruding direction.

6. The falling prevention apparatus according to claim 2, further comprising a fastener to fasten the falling prevention member to the attachment,
wherein the attachment position changer includes multiple fastening holes arrayed in the protruding direction on the attachment, and
the multiple fastening holes restrict displacement of the fastener in both of:
the protruding direction; and
a transverse direction orthogonal to the protruding direction.

7. The falling prevention apparatus according to claim 3,
wherein the falling prevention member further has another fastening hole having a slotted hole on the falling prevention member, the slotted hole elongated in the protrusion direction,
the fastener is insertable into said another fastening hole in the insertion direction, and
the fastener is:
allowed to displace along said another fastening hole in the protrusion direction; and
restricted to displace in the transverse direction.

8. The falling prevention apparatus according to claim 4,
wherein the falling prevention member further has another fastening hole having a slotted hole on the attachment, the slotted hole elongated in the protruding direction,
the fastener is insertable into said another fastening hole in the insertion direction, and
the fastener is:
allowed to displace along said another fastening hole in the protruding direction; and
restricted to displace in the transverse direction.

9. The falling prevention apparatus according to claim 7,
wherein the attachment position changer includes multiple fastening holes arrayed in the protruding direction on the falling prevention member,
said another fastening hole has a longitudinal length equal to or longer than the protrusion amount of the falling prevention member from the side face of the target apparatus in the protruding direction, and
the protrusion amount is according to a distance between each end of the multiple fastening holes in the protrusion direction.

10. The falling prevention apparatus according to claim 1,
wherein the falling prevention member includes:
a rigid plate including:
a vertical surface portion; and
a horizontal surface portion having one end attached to a lower portion of the vertical surface portion and extending in the protruding direction, and
an inclined plate inclined downward from an upper portion of the vertical surface portion toward another end of the horizontal surface portion in the protruding direction.

11. An image forming apparatus comprising the falling prevention apparatus according to claim 1,
wherein the image forming apparatus is installed on an installation surface,
the protrusion amount changer decreases the protrusion amount to a minimum amount to reduce an angle equal to or larger than a predetermined angle, and
the angle is formed by:
a straight line connecting a gravity center of the target apparatus on a horizontal surface and an end portion of the falling prevention member in the protruding direction; and
a vertical line.

12. An image forming apparatus comprising the falling prevention apparatus according to claim 1,
wherein the image forming apparatus is installed on an installation surface,
the protrusion amount changer increases the protrusion amount to a maximum amount to increase an angle equal to or larger than a predetermined angle, and
the angle is formed by:
a straight line connecting a gravity center of the target apparatus on a horizontal surface and an end portion of the falling prevention member in the protruding direction; and
a vertical line.

13. An image forming apparatus comprising the falling prevention apparatus according to claim 1 installed on an installation surface.
